(19) United States
(12) Patent Application Publication
(10) Pub. No.: US 2022/0316785 A1
(43) Pub. Date: Oct. 6, 2022

(54) LOW PRESSURE CARBON SNOW INJECTOR

(71) Applicant: L'Air Liquide, Societe Anonyme pour l'Etude et l’Exploitation des Procedes Georges Claude, Paris (FR)

(72) Inventors: Marco EMANUELLI, Milan (IT); Silvano TROTTA, Milan (IT)

(73) Assignee: L'Air Liquide, Societe Anonyme pour l'Etude et l’Exploitation des Procedes Georges Claude, Paris (FR)

(21) Appl. No.: 17/711,801

(22) Filed: Apr. 1, 2022

(30) Foreign Application Priority Data
Apr. 1, 2021 (EP) EP 21315060.0

(51) Int. Cl. F25D 3/12; C01B 32/55

(52) U.S. Cl. CPC F25D 3/12; C01B 32/55; A21D 6/001

(57) ABSTRACT

An equipment for making CO₂ snow, ready to be injected in an installation using such a snow, notably an installation of the food industry, equipment comprising a snow horn and a J-Tube.

### CROSS-REFERENCE TO RELATED APPLICATIONS

This application claims the benefit of priority under 35 U.S.C. § 119 (a) and (b) to EP patent application No. EP 21315060.0, filed Apr. 1, 2021, the entire contents of which are incorporated herein by reference.

### BACKGROUND

### Field of the Invention

The present invention deals with the devices for making CO₂ snow, ready to be injected in an installation using such a snow, notably an installation of the food industry.

The invention is particularly interested in the installations (mixers) for cooling dough products, cooling being obtained thanks to the injection of CO₂ snow, with the following objectives:
to show a better distribution of the snow inside the mixer, thanks to the introduction of the snow with a low kinetic energy, therefore to have a more homogeneous final temperature of the mixture.
to reduce the amount of gas injected inside the mixer.

### Related Art

As well known by the skilled man, liquid storages of carbon dioxide (CO₂) are high pressure containers (average pressure is above 18 bar). The end user who therefore wants to create carbon snow starting from liquid storage will have to face the various problems that high pressure entails.

Currently, two different devices are used for making CO₂ snow:
1. The Snow Horns: the system, installed directly on the lid of such dough mixers, expands the liquid CO₂ by pouring the carbonic snow and gas (generated by the change of state) onto the dough.
The limits of this system are linked to the enormous amount of energy that is released inside the mixer. This energy interferes with the volatile ingredients of the dough (flour, cocoa, yeast, etc . . . ), dirtying the equipment and dispersing part of the ingredients.
2. the “J Tube” systems: The expansion of the liquid phase, in this system, does not take place on the lid of the mixer but at the inlet of the equipment. In this way, thanks to a system of tangential pipes, the gaseous phase, lighter than the solid one, is separated thanks to the centrifugal force and brought directly to the outside. The gaseous phase therefore does not enter the dough, limiting the amount of energy that interferes with the ingredients.

The limits of this system are related to the amount of energy that the solid phase brings inside the mixer

### SUMMARY OF THE INVENTION

As will be described more in details below, the system proposed by the present invention allows the obtention of a snow, produced by the expansion of the liquid carbon dioxide of the tank source, at a much lower pressure.

For this purpose, the combination of the following means are implemented, connected to each other and preferably inserted inside a vacuum insulation in order to reduce thermal re-entry from the outside and to improve the efficiency of the system:

1. a Calibrated orifice, or any other expansion mean, but a calibrated orifice is preferred according to the invention.

2. a J-tube.

3. a Snow horn.

4. a Venturi system.

5. a Gas extraction pipe.
a) a Calibrated orifice

The expansion of liquid carbon dioxide, thanks to the transition of state, transforms a part of the liquid flow into gas and a part into solid. The calibrated orifice, installed at the inlet of the equipment, allows the complete change of state of the liquid flow, transforming it into many small flows. At this point the energy of the flow begins to reduce. Depending on the required carbon snow flow rate, the calibrated orifice will be made with a suitable number and size of holes.

### BRIEF DESCRIPTION OF THE FIGURES

FIG. 1 is a photograph of an embodiment of the invention.

FIG. 2a is a photograph of a transition zone (plate) between the J Tube and the main and secondary pipes of the invention.

FIG. 2b is a schematic view of the transition zone (plate) of the invention illustrating its operation.

### DETAILED DESCRIPTION OF THE INVENTION

According to the invention a multiple holes calibrated orifice is preferred, instead of a one-hole orifice.

The calibrated orifices can be made for example with 24 mm diameter stainless steel discs. This size shows ideal conditions for fitting into the downstream J-tube inlet fitting and easily replaced.

The holes, which make up the calibrated orifice, can have a diameter ranging between 1.1 mm and 1.9 mm, for the purpose of illustration to better understand the present proposal.

This dimension seems to show ideal conditions to have the maximum result in terms of transition of state for the incoming liquid.

A great advantage, in having a calibrated orifice with multiple holes instead of the traditional ones with only one hole, is to have the smaller size of the snow crystals. A smaller size of the snow crystals means better heat exchange between snow and the product to be cooled and a better homogenization of the temperature of the mixture. The final discharge of carbonic snow will then be calculated with the number and diameter of the holes that make up the calibrated orifice.

As will appear clearly to the skilled man, a calibrated orifice is a very relevant point of the system proposed here.

The calibrated orifice is installed at the inlet, just before the J-tube. Then the orifice transforms the carbon dioxide into solid/gas, and the J-tube, as will be explained below, divides, separates the gas from the solid, bringing it to the snow horn, the snow horn gently making the snow fall into the equipment or process using such a snow, for example a mixer in the food industry.

b) a J-Tube

The flow of the liquid, once expanded, giving rise to the production of a diphasic gas-solid mixture, passes through a suitably bent tube (called traditionally a “J-tube” due to its shape) inside which the two phases, thanks to the centrifugal force, tend to separate: the solid phase, heavier than the gaseous phase, tends to go outwards of the tube, allowing that the solid phase is conveyed to a pipe that we will call a main pipe, and the gas phase is conveyed inside another pipe that we will call a secondary pipe

c) a transition plate wherein the end of the J-Tube fits into the plate, the plate being in its downstream side in gas connexion with two pipes, a main pipe and a secondary pipe, the main one at the top being able to carry the solid snow phase, and the second one at the bottom being able to carry the gaseous phase.

d) a Snow horn

At the exit of the J-tube, the main pipe, carrying snow is connected tangentially to the top of a cylinder (called snow horn). The high velocity of the fluid forces the solid phase (carbon snow) to descend towards the bottom of the cylinder along its circumference before falling outside. At this point, the lighter gas phase (which is generated by sublimation of the solid phase) is released inside the cylinder without a preferential path. The motion of the gaseous fluid, due to its low temperature, is descending towards the outside of the snow horn.

e) a Venturi system

At the outlet of the J-tube, the secondary pipe (the one carrying gas) is connected to a venturi system installed on the top of the snow horn. The high speed of the fluid, harnessed inside the venturi system, generates a reduction in pressure inside the cylinder which sucks up the gaseous phase formed by sublimation of the solid phase which runs inside the cylinder. The part of gas exiting the J-tube, used to create the depression, and the part of gas intercepted by the venturi system are conveyed outside.

f) a Gas extraction pipe To increase the efficiency of the Venturi system and to distribute its suction effect along the entire cylinder, a perforated pipe is advantageously installed inside the snow horn. This pipe, connected to the Venturi system above, allows the gas formed to be sucked up along the entire length of the snow horn.

In other words, the system takes advantage of the benefits of both devices (J Tube and Snow horn) and eliminates their main limitations.

In fact, the capacity of the J-tube is exploited to immediately separate most of the gas that is produced by the passage of state. This gas flow, at high pressure, before being evacuated to the outside, is used inside the Venturi system to generate a vacuum inside the snow horn in order to further eliminate the gas that the J-tube has not been able to separate.

After the J-tube, the flow of carbon snow, which still has a great deal of energy, is injected into the snow horn tangentially to the circumference. In this way the carbonic snow loses part of its energy thanks to the friction generated between the flow and the walls of the snow horn. The end result is a flow of carbon snow that falls inside the mixer with a small amount of gas and low kinetic energy.

The invention deals therefore with an equipment for making CO₂ snow, ready to be injected in an installation using such a snow, notably an installation of the food industry, equipment comprising the following elements:
a) a device for expanding liquid carbon dioxide, for example a Calibrated orifice, able to receive the liquid carbon dioxide and to transform a part of the liquid flow into gas and a part into solid, said device being installed at the inlet of the equipment,
b) a J-Tube, said expansion device being installed at the inlet of the J-tube, the J-Tube being able to separate the diphasic gas-solid mixture produced by said expansion device into two phases, a solid phase heavier than the gaseous phase, tending to go outwards of the tube, and a gas phase tending to go on the inwards part of the Tube;
c) a transition plate wherein the end of the J-Tube fits into the plate, the plate being in its downstream side in gas connexion with two pipes, a main pipe and a secondary pipe, the main one at the top being able to carry the solid snow phase, and the second one at the bottom being able to carry the gaseous phase.
d) a Snow Horn: wherein said main pipe is connected tangentially to the top of the Snow Horn.
   and
e) a Venturi System wherein said secondary pipe is connected to the Venturi System which is installed on the top of the snow horn, in order that the high speed of the fluid, harnessed inside the Venturi System, generates a reduction in pressure inside the Horn, making it possible the sucking up of the gaseous phase formed by sublimation of the solid phase running inside the Horn, wherein the part of gas exiting the J-tube, used to create the depression, and the part of gas intercepted by the Venturi system are conveyed outside of the equipment.

The figures attached will help to better understand the present invention.

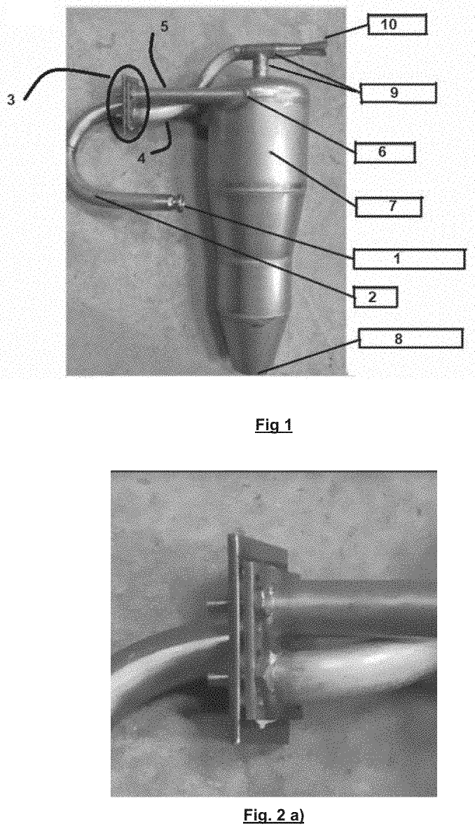

The following elements can be recognized on the FIG. 1 annexed:
1: orifice
2: J Tube
3: transition zone (plate) between the J Tube and the main and secondary pipes
4: secondary pipe
5: main pipe
6: snow inlet inside the horn
7: horn
8: snow outlet to the user station
9: venturi system
10: gas outlet

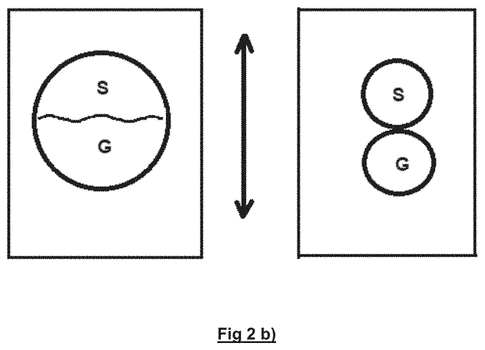

The FIGS. 2a) and 2b) in annex shows a schematic representation of the transition device 3 and help to better understand the structure and operation of this transition device:
the left plate is “fixed” and connected (for example welded) to the end of the J-Tube;
the right plate is “movable”, it can go up and down;
the upper pipe connected to the right plate is able to carry the snow to the snow horn whereas the lower pipe connected to the right plate is able to carry the gas phase to the Venturi system and from there to the outside;
on the left part of the FIG. 2b), one can see in section the end of the J-tube that fits into the plate;
on the right side of the FIG. 2b) on can see the connection of the two pipes main and secondary, the first one at the top carrying the solid and the second one at the bottom carrying gas;

And the remarkable point about this transition plate lies in the fact that the following adjustment becomes possible:
when the right plate is lowered, one gives the solid and diphasic part prevalence to enter the downstream user station;
whereas when the right plate is raised, one gives the gas and diphasic part prevalence to enter the Venturi system;

this adjustment being performed at the time of the installation of the equipment.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1. A device for making CO₂ snow, ready to for being injected into food industry equipment for use thereof, comprising:
a calibrated orifice adapted to receive a flow of liquid carbon dioxide and to transform part of said flow of liquid carbon dioxide into a diphasic mixture of gaseous and solid carbon dioxide, said calibrated orifice being installed at an inlet of said device;
a J-Tube, said calibrated orifice being installed at an inlet of the J-tube, the J-Tube being able to separate the diphasic mixture produced into a solid phase directed to an outer portion of said J-Tube and a gaseous phase directed to an inner portion of said J-Tube;
a transition plate, wherein an end of the J-Tube fits into the plate, a downstream end of the plate being in in gas connection with a main pipe adapted to carry the solid phase and a secondary pipe adapted to carry the gaseous phase;
a snow horn, said main pipe being connected tangentially to a top of the snow horn; and
a Venturi system installed on a top of the snow horn, wherein said secondary pipe is connected to the Venturi system such that a speed of fluid harnessed inside the Venturi system generates a reduction in pressure inside the snow horn, thereby evacuating the gaseous phase inside the horn, wherein each of a part of the gaseous phase exits the J-tube used as the fluid harnessed inside the Venturi system for achieving the reduction of pressure and a part of the gaseous phase intercepted by the Venturi system is conveyed outside of the equipment.

2. The device of claim 1, further comprising a perforated gas extraction pipe installed inside the snow horn and being connected to the Venturi system to allow the gaseous phase formed inside the horn to be evacuated up along an entire length of the snow horn.

3. The device of claim 1, wherein said transition plate comprises:
a left plate which is fixed and connected to an end of the J-Tube; and
a right plate which is movable up and down with respect to the left plate, the right plate being in gas connection with said main and secondary pipes.
